(19) United States
(12) Patent Application Publication
(10) Pub. No.: US 2004/0094861 A1
(43) Pub. Date: May 20, 2004

(54) Method for forming foamable boards

(76) Inventor: Jui Yang Chang, Taichung (TW)

Correspondence Address: Jui Yang Chang, P.O. Box 63-298, Taichung, 406, TW

(21) Appl. No.: 10/694,604

(22) Filed: Oct. 24, 2003

Related U.S. Application Data
(63) Continuation-in-part of application No. 10/298,002, filed on Nov. 18, 2002, now Pat. No. 6,712,372.

(51) Int. Cl. B29C 47/00; B32B 31/14; B29C 47/12

(52) U.S. Cl. 264/177.17; 156/78; 264/211.12

(57) ABSTRACT

A method for forming boards of foamable materials, includes preparing two plastic materials and disposing or extruding and mating a foamable material between the plastic materials, to form a board having two outer layers formed by the plastic materials, and an intermediate layer formed by the foamable material. An air or a foamable agent may be injected or combined into the foamable material before conducting the extruding process, in order to foam or expand the foamable material, and to decrease the density and the weight of the foamable material and the boards. The air may be selectable from carbon dioxide, propane, or butane, or other air.

The present application is a continuation-in-part of U.S. patent application Ser. No. 10/298,002, filed 04 Nov. 2002, pending.

### BACKGROUND OF THE INVENTION

1. Field of the Invention

The present invention relates to a method, and more particularly to a method for forming boards of foamable or expandable materials and/or plastic materials.

2. Description of the Prior Art

Typical plastic plates or boards have been widely used for making various kinds of objects, such as files, albums, various casings, suitcases, luggage members, packaging materials for food or the like, decorative materials for vehicles, architecture materials, sports exercisers, etc.

Normally, the typical plastic plates or boards include a less |strength such that the typical plastic plates or boards may be easily broken or damaged easily. In order to increase the strength of the typical plastic plates or boards, the materials may be changed or improved to increase the density of the typical plastic plates or boards.

However, when the density of the typical plastic plates or boards is greatly increased, the weight of the typical plastic plates or boards will also be greatly increased, such that the typical plastic plates or boards are not good for manufacturing various objects.

The other typical plates or boards that are made of spongy or foamable or expandable materials may include a greatly reduced weight. However, the typical spongy or foamable or expandable plates or boards may include a greatly reduced strength and may include a rough or serrated or uneven outer surface such that the typical spongy or foamable plates or boards also may not be used for manufacturing various objects.

The present invention has arisen to mitigate and/or obviate the afore-described disadvantages of the conventional methods for forming boards of foamable materials.

### SUMMARY OF THE INVENTION

The primary objective of the present invention is to provide a method for forming boards having an intermediate layer of foamable or expandable materials, to increase the strength of the boards, and to decrease the weight of the boards.

In accordance with one aspect of the invention, there is provided a method for forming boards of foamable or expandable materials, the method comprising extruding two plastic materials, extruding a foamable material to have the foamable material disposed and arranged between the plastic materials, and merging the plastic materials and the foamable material together, to form the board having two outer layers formed by the plastic materials, and an intermediate layer formed by the foamable material.

An air may further be injected into the foamable material to expand the foamable material, and may be selectable from carbon dioxide, propane, or butane.

A first mold device includes two outer flow passage to receive the plastic materials, and an intermediate flow passage to receive the foamable material. A second mold device may receive the mated plastic materials and foamable material, and to form the mated plastic materials and foamable material into a planar member.

The plastic materials and the foamable material may be rolled and compressed together to form the board, and may then be cooled after merging the plastic materials and the foamable material together, and may then be cut. Alternatively, a foamable agent may be filled into the foamable material before conducting the extruding process of the foamable material.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an object to be manufactured with a method in accordance with the present invention;

FIG. 2 is a partial perspective view of the object manufactured with the method for forming boards of foamable materials;

FIG. 3 is an enlarged partial perspective view of the object as shown in FIG. 1;

FIG. 4 is a partial cross sectional view taken along lines 4-4 of FIG. 2;

FIG. 5 is a flow chart illustrating the procedures of the method for forming boards of foamable materials;

FIG. 6 is a flow chart similar to FIG. 5, illustrating the other procedures of the method for forming boards of foamable materials; and

FIG. 7 is a partial top plan schematic view illustrating the extruding machine for forming the boards of foamable materials;

FIG. 8 is a partial cross sectional view taken along lines 8-8 of FIG. 7;

FIG. 9 is a partial cross sectional view illustrating the molding device for forming the boards of foamable materials;

FIG. 10 is a partial cross sectional view taken along lines 10-10 of FIG. 9;

FIGS. 11, 12, 13, 14 are perspective views illustrating the other objects to be manufactured with the method for forming boards of foamable materials.

### DETAILED DESCRIPTION OF THE PREFERRED EMBODIMENT

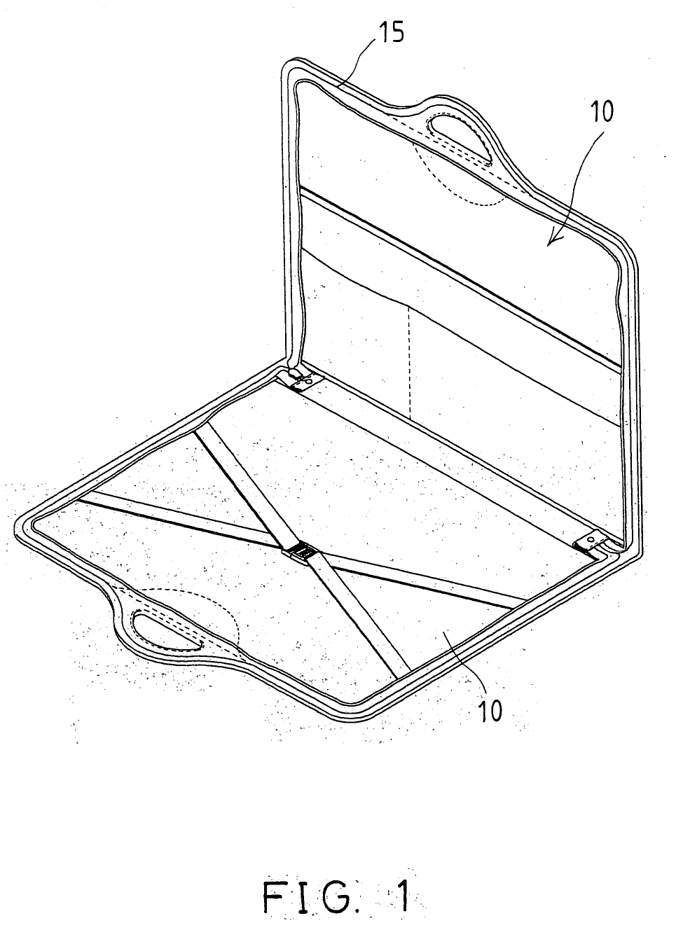

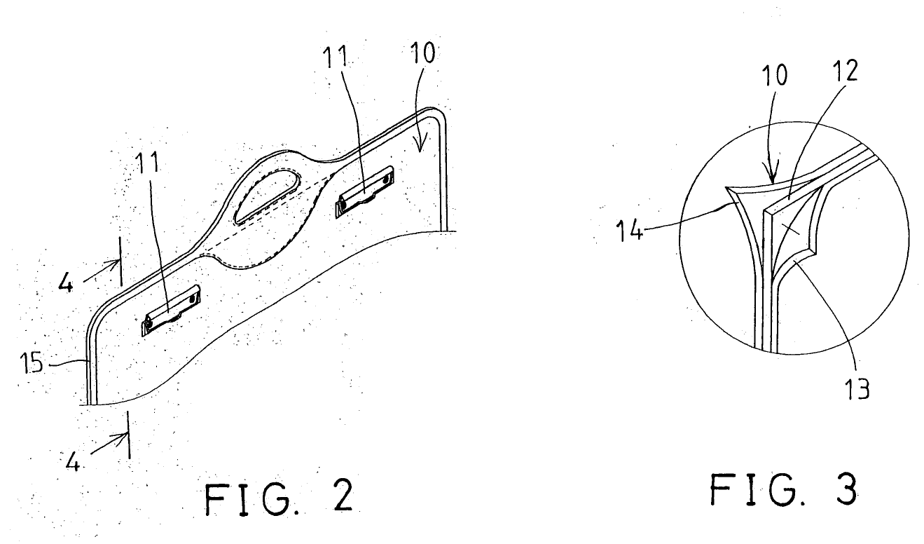

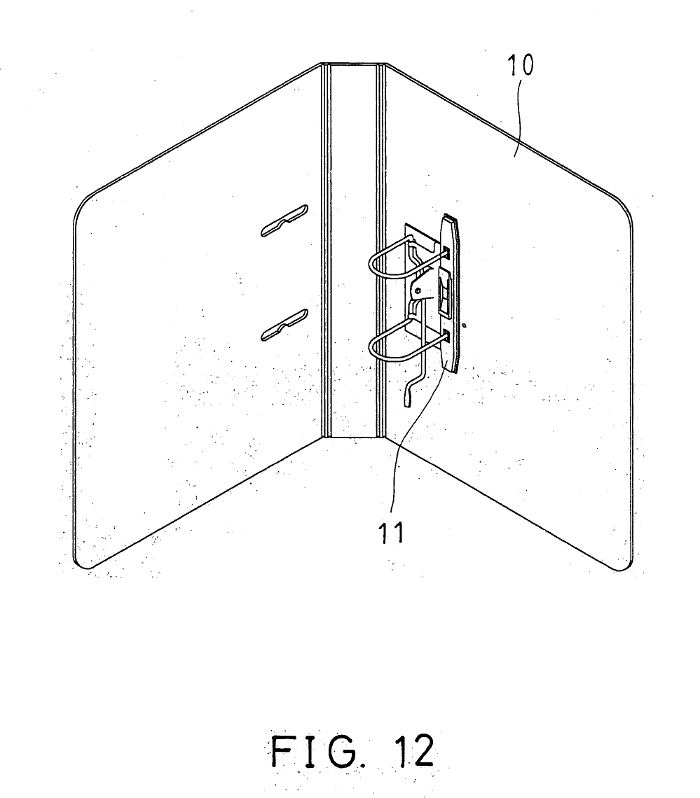

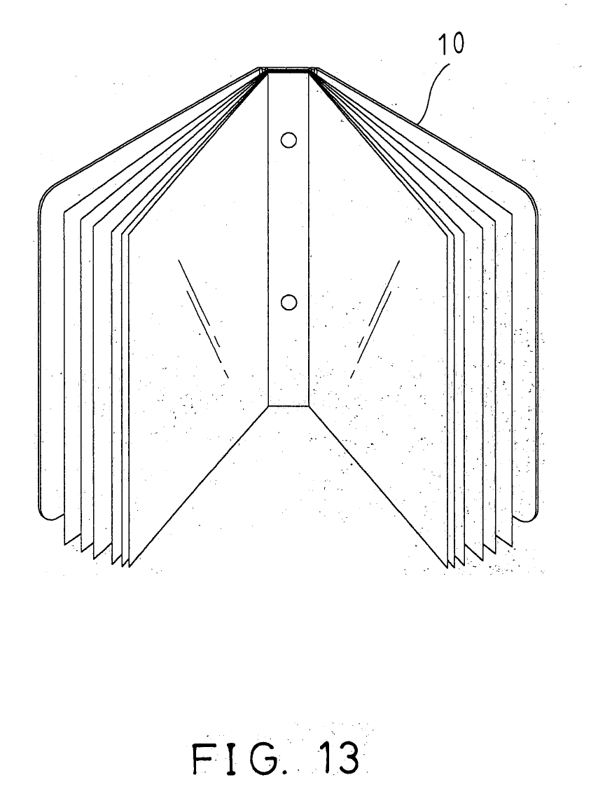

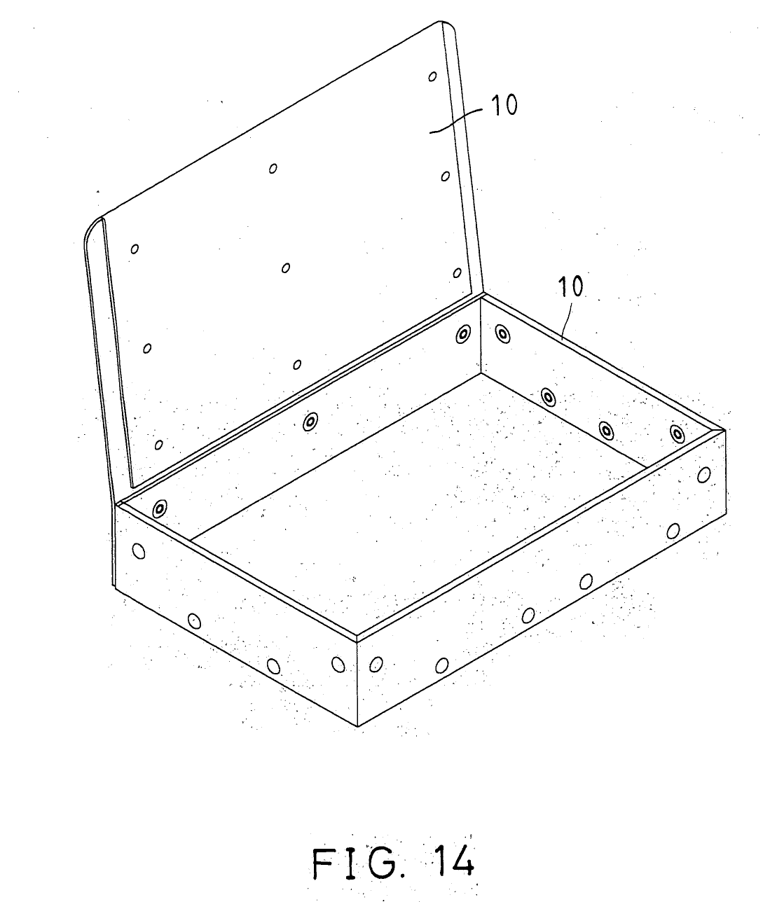

Referring to the drawings, and initially to FIGS. 1-4, a method in accordance with the present invention is provided for forming boards 10 that may be used for making various objects, such as the suitcases as shown in FIG. 1, the files as shown in FIGS. 11-13, the casings, or housings, or luggage members, or packaging materials as shown in FIG. 14, etc. The objects may include one or more clips or fasteners 11 attached thereto (FIGS. 2, 11, 12), for securing sheet members therein.

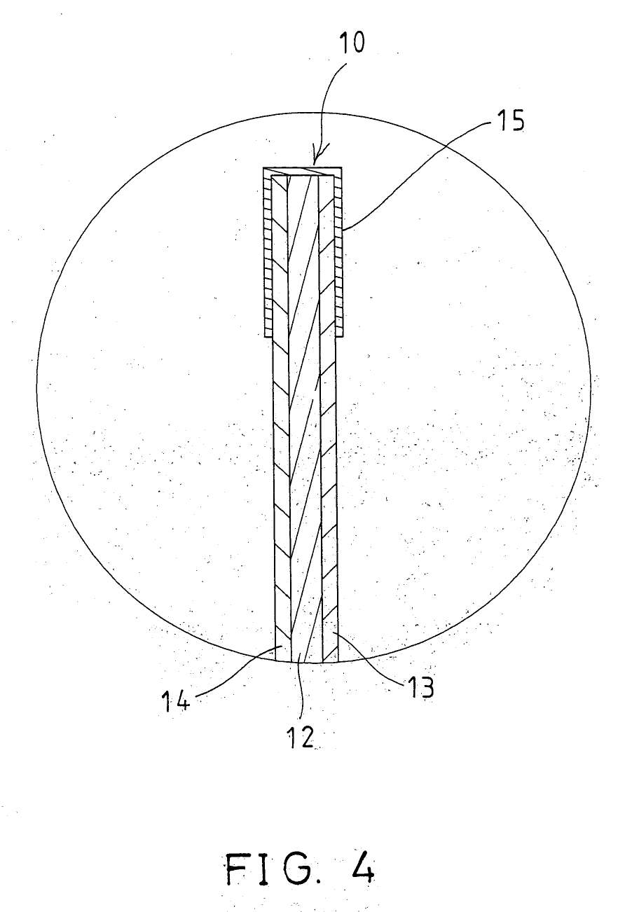

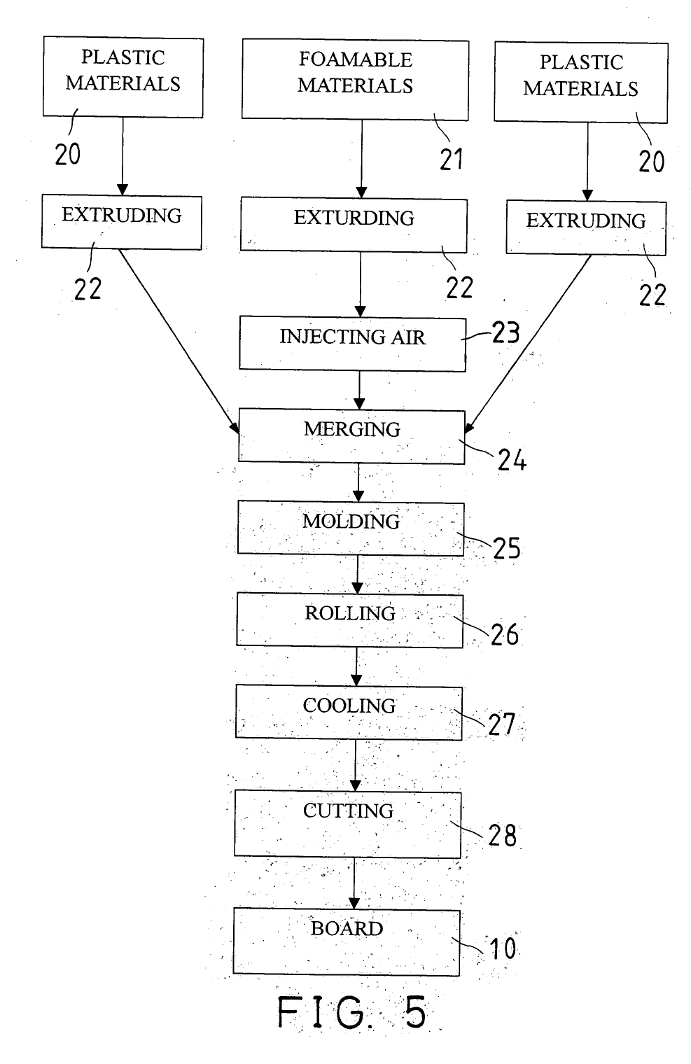

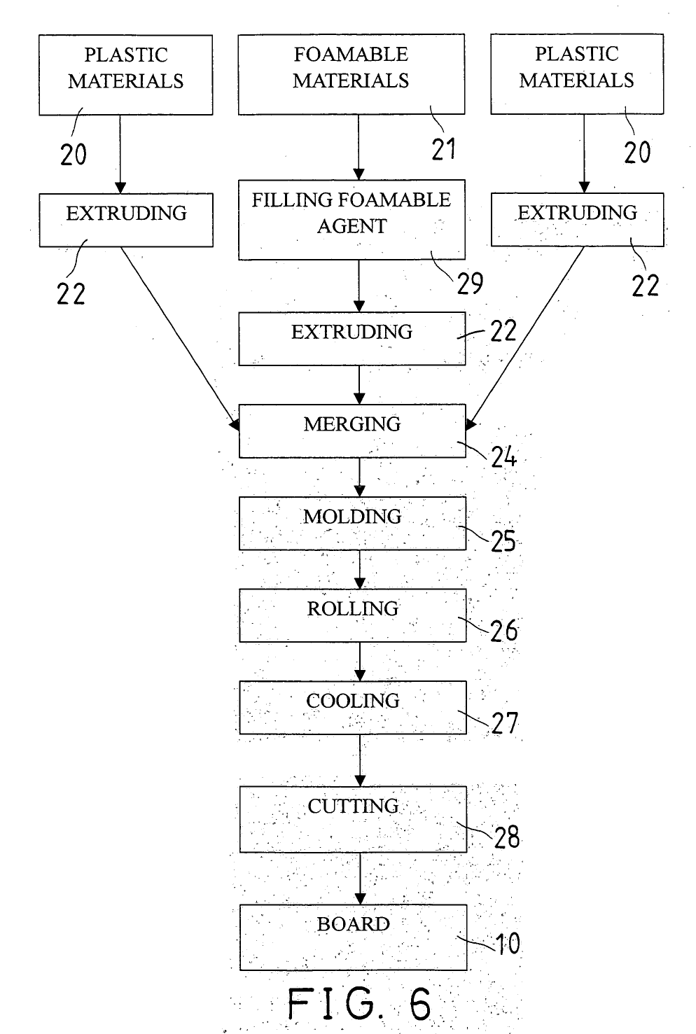

As shown in FIGS. 3 and 4, the board 10 an intermediate layer 12 of foamable or expandable materials 21 (FIGS. 5, 6), and two outer layers 13, 14 of plastic materials 20 (FIGS. 5, 6) formed or secured together by such as extruding and/or molding processes. A protective rim 15 may be attached to the outer peripheral portion of the board 10, as shown in FIGS. 1, 2 and 4, for protecting the outer peripheral portion of the board 10, and for preventing the outer peripheral portion of the board 10 from being damaged.

Referring next to FIG. 5, two plastic materials 20 are provided for forming the outer layers 13, 14, and are squeezed or fed or extruded in processes 22 before conducting a merging process 24 and a molding process 25. A foamable material 21 is provided for forming the intermediate layer 12, and is also squeezed or fed or extruded in processes 22 before conducting the merging process 24 and the molding process 25.

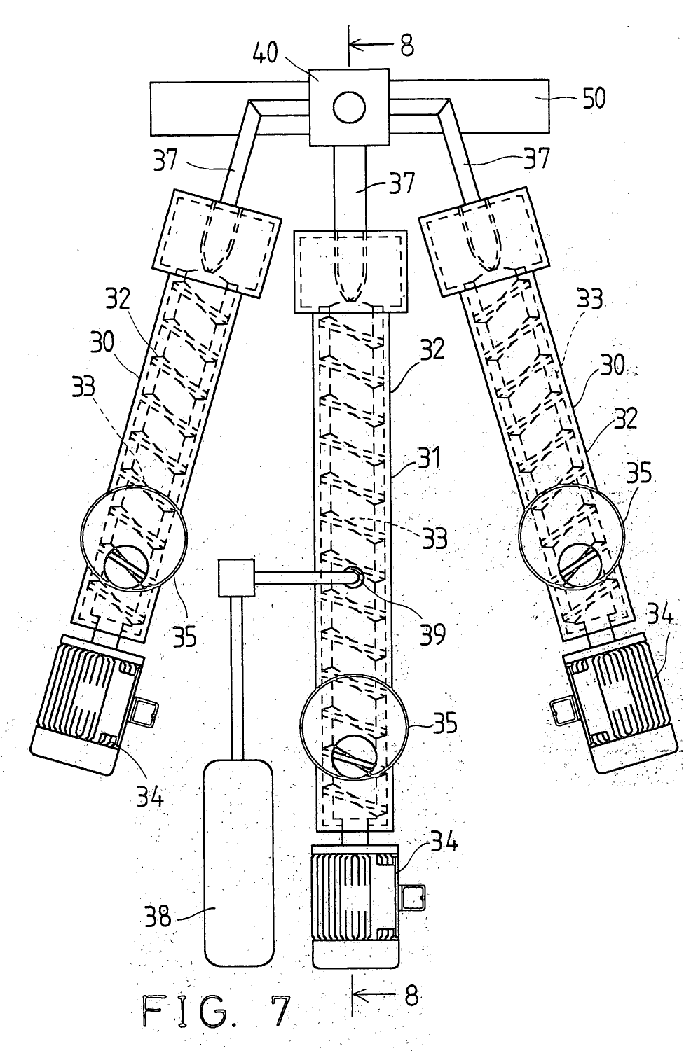

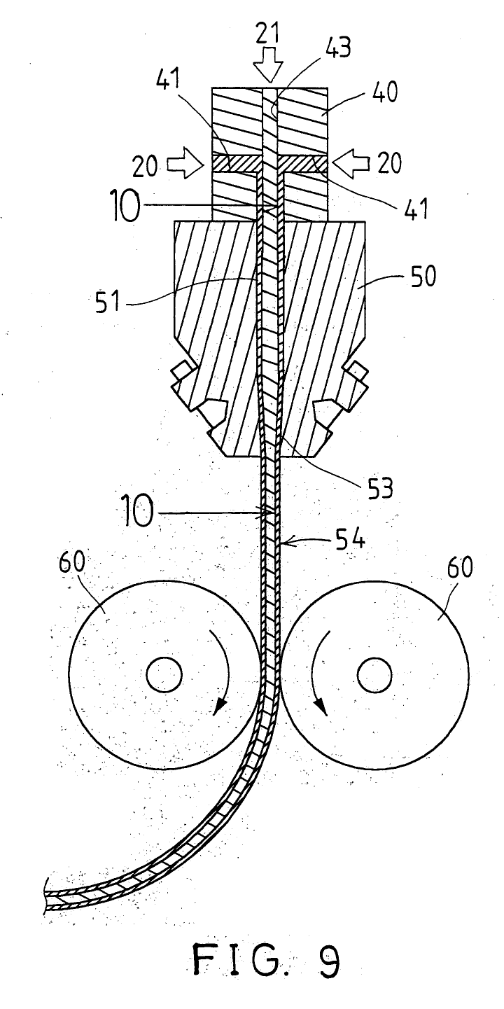

For example, as shown in FIG. 7, the two outer plastic materials 20 and the inner foamable material 21 may each be supplied and extruded or fed by an extruding device 30, 31 of an extruding machine, or the like, and may be supplied and extruded or fed into the two outer and an intermediate flow passages 41, 43 of a mating or distributor mold 40, as shown in FIG. 9.

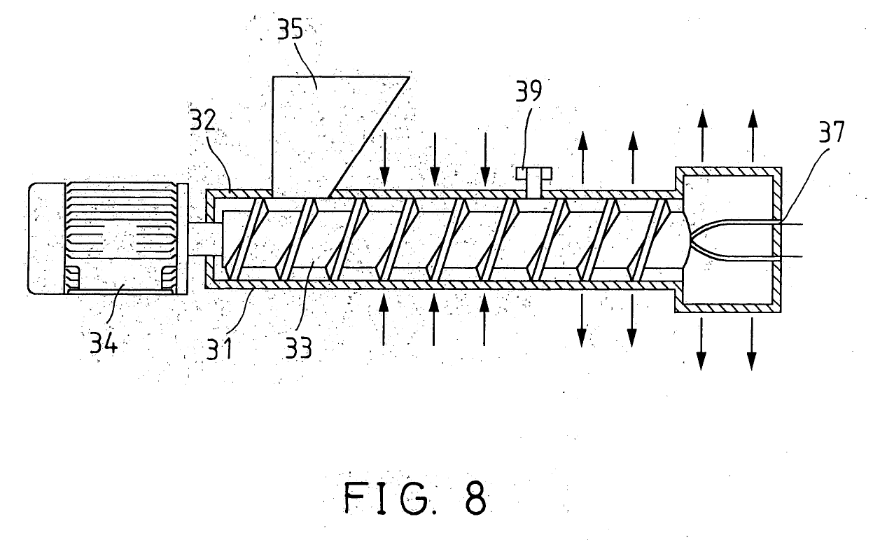

As shown in FIG. 8, each of the extruding devices 30, 31 includes a housing 32, a screw 33 rotatably received in the housing 32, a motor 34 coupled to the screw 33 for rotating and driving the screw 33 relative to the housing 32, an inlet 35 for filling the outer plastic materials 20 and the inner foamable material 21 into the housings 32 of the extruding devices 30, 31 respectively, and an outlet 37 coupled to the flow passages 41, 43 of the distributor mold 40 respectively, for supplying or feeding the outer plastic, materials 20 and the inner foamable material 21 into the flow passages 41, 43 of the distributor mold 40 respectively.

Referring again to FIG. 5 before the foamable material 21 is fed and merged with the other two plastic materials 20, or before the foamable material 21 is subjected to the distributing or mating or merging process 24, and an air injecting process 23 is provided to fill or inject an air into the foamable material 21 that is normally in a liquid or pasty like status, before or after the foamable material 21 is subjected to the extruding process 22, in order to foam or to expand the foamable material 21.

For example, the air may be selected from carbon dioxide (CO₂), propane, butane, or the like. As shown in FIG. 7, a bottle or container 38 may be used to receive or store the pressurized air or carbon dioxide (CO₂), propane, butane, or the like, and may be coupled to an entrance 39 of the intermediate extruding device 31 (FIGS. 7, 8), for filling the air into the foamable material 21 that is or will be extruded by the extruding device 31.

In the merging process 24, the extruded materials 20, 21 will be mated or merged with each other, to have the inner foamable material 21 to be disposed or arranged between the two outer plastic materials 20, and thus to form the foamable intermediate layer 12 and the two outer layers 13, 14 of the board 10 respectively. The mated or merged materials 20, 21 will then be sent to another mold device 50.

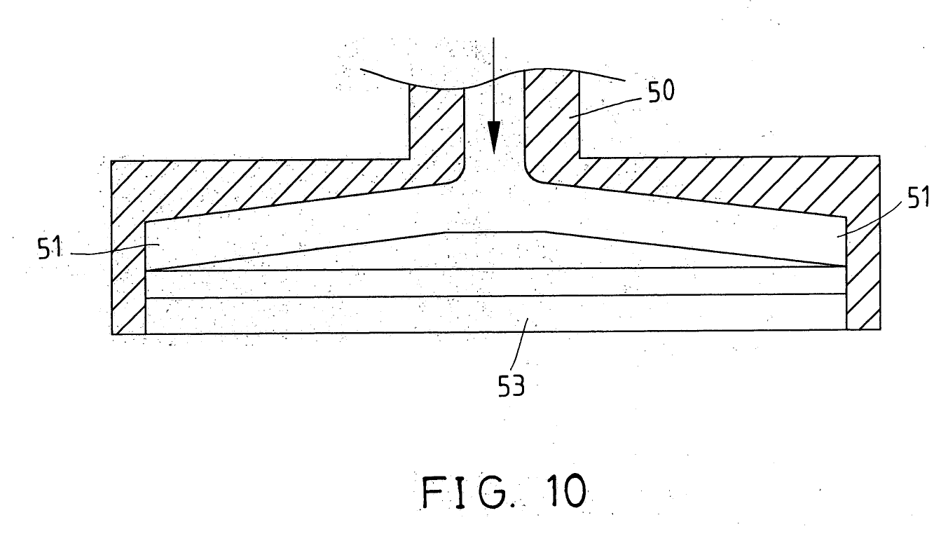

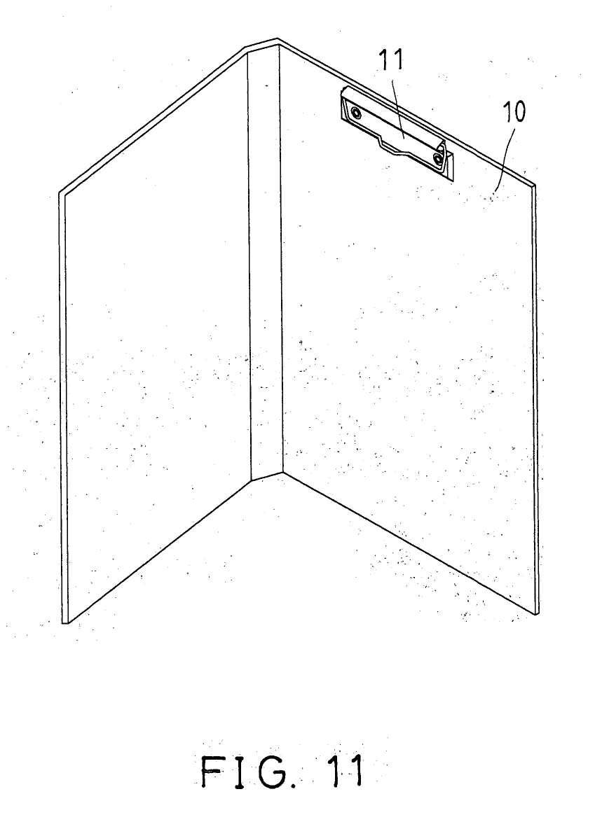

For example, as shown in FIGS. 9 and 10, the mold device 50 may be an expanding mold device 50 and may include two inclined channels 51 for evenly distributing the mated or merged materials 20, 21 laterally or sidewise into a planar and thinner pathway 53, within which the mated or merged materials 20, 21 will be forced to form a planar or sheet like member 54 (FIG. 9).

As also shown in FIG. 9, the planar or sheet like member 54 will then be optionally or selectively forced or squeezed or compressed or rolled by two or more rollers 60 of a rolling machine, in a rolling process 26 (FIGS. 5, 6), in order to force and compress the mated or merged materials 20, 21 together, and so as to allow the mated or merged materials 20, 21 to be further solidly secured together and to form the planar or sheet like member 54 (FIG. 9).

The mated or merged materials 20, 21 may also be arranged to form the planar or sheet like member 54 (FIG. 9) directly after the mold device 40, without the mold device 50 and the rollers 60, or may be formed into the planar or sheet like member 54 (FIG. 9) with the mold device 40 and the rollers 60, but without the mold device 50.

After the planar or sheet like member 54 is formed, the planar or sheet like member 54 will then be cooled in a cooling process 27, and/or will be trimmed or cut in a cutting process 28, in order to form the board 10. It is to be noted that the foamable intermediate layer 12 may be made of waste or recycled plastic or foamable materials, in order to reduce the pollution to the environment, and to protect our environment.

The filling or injecting of the air into the foamable material 21 may decrease the density of the foamable material 21, in order to expand and to form the foamable intermediate layer 12 having a density ranging from 0.03 to 0.6 g/cm³. The board 10 may thus have a weight decreasing up to 50 to 95% as compared with that of the typical boards of plastic materials.

Alternatively or selectively, as shown in FIG. 6, instead of injecting the air into the liquid or pasty foamable material 21, a foamable agent or a vulcanizing agent may be filled into the foamable material 21 in a filling process 29, before the foamable material 21 is subjected to the extruding process 22, and/or before the foamable material 21 is subjected to the merging 24 or molding process 25. The foamable intermediate layer 12 thus formed may include a density ranging from 0.5 to 0.8 g/cm³.

As shown in FIG. 7, the foamable agent or the vulcanizing agent may be filled into the foamable material 21 before the foamable material 21 is fed or filled into the inlet 35 of the housing 32 of the extruding device 31. The foamable material 21 may be foamed or expanded by the filling of the foamable agent or the vulcanizing agent, in order to form the foamable intermediate layer 12 having a decreased density.

It is to be noted that the provision and the engagement of the intermediate foamable materials between the plastic outer layers may increase the strength of the boards 10, and to decrease the weight of the boards. In addition, the intermediate foamable materials may provide a greater resilience or cushioning effect to the boards 10.

Accordingly, the method in accordance with the present invention includes an intermediate layer of foamable materials, to increase the strength of the boards, and to decrease the weight of the boards.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for forming a board, said method comprising:
extruding two plastic materials,
extruding a foamable material to have said foamable material disposed and arranged between said plastic materials, and
merging said plastic materials and said foamable material together, to form the board having two outer layers formed by said plastic materials, and an intermediate layer formed by said foamable material.

2. The method as claimed in claim 1 further comprising injecting an air into said foamable material to expand said foamable material.

3. The method as claimed in claim 2, wherein said air is selectable from carbon dioxide, propane, or butane.

4. The method as claimed in claim 1 further comprising providing a first mold device having two outer flow passage to receive said plastic materials respectively, and, an intermediate flow passage to receive said foamable material, in order to mate said plastic materials and said foamable material together.

5. The method as claimed in claim 4 further comprising providing a second mold device to receive said mated plastic materials and foamable material, and to form said mated plastic materials and foamable material into a planar member.

6. The method as claimed in claim 5 further comprising providing at least one inclined channel and a planar and thinner pathway to distribute said mated plastic materials and foamable material into the planar member.

7. The method as claimed in claim 1 further comprising rolling said plastic materials and said foamable material together to form the board.

8. The method as claimed in claim 1 further comprising cooling said plastic materials and said foamable material after merging said plastic materials and said foamable material together.

9. The method as claimed in claim 8 further comprising cutting said plastic materials and said foamable material after conducting said cooling process.

10. The method as claimed in claim 1 further comprising filling a foamable agent into said foamable material before conducting said extruding process of said foamable material.
